(19) United States
(12) Patent Application Publication
(10) Pub. No.: US 2012/0324850 A1
(43) Pub. Date: Dec. 27, 2012

(54) Air Filter Element with Covered Terminal Disks

(75) Inventors: Klemens Dworatzek, Edingen (DE); Ralf Bauder, Ketsch (DE)

(73) Assignee: MANN+HUMMEL GMBH, Ludwigsburg (DE)

(21) Appl. No.: 12/376,224

(22) PCT Filed: Jul. 27, 2007
(86) PCT No.: PCT/EP07/57749

§ 371 Date: Nov. 2, 2009

(30) Foreign Application Priority Data
Aug. 3, 2006 (DE) 20-2006-011-989.2

(51) Int. Cl. B01D 29/11; B29C 45/14

(52) U.S. Cl. 55/498; 264/262

(57) ABSTRACT

In order to provide a seal function and a protection of the sealing surfaces for an air filter element (10) comprising a cylindrical tubular filter bellows (11) that is closed off at the end faces by a terminal disk (20, 20′), respectively, which each have at least one annular seal (22) or an annular seal section of a sealing member, the annular seal (22) is covered by a manually removable cover ring and/or a cover disk (30′).

### TECHNICAL FIELD

The invention concerns an air filter element comprising a cylindrical tubular filter bellows that is closed off at its end faces by a terminal disk, respectively, that each comprise at least one annular seal or an annular seal section of a sealing member.

### PRIOR ART

Terminal disks are required in order to be able to provide a sealing action of the filter element in an air filter housing and to force the predetermined radial flow path through the filter bellows. At least one terminal disk is provided on the exterior side that is facing away from the filter bellows with an annular sealing member. The sealing member is conventionally produced such that the terminal disk is inserted into a casting mold and then a liquid polymer material is filled in and flows into an annular penetration or recess at the terminal disk and/or the casting mold. After hardening or cross-linking the casting mold is removed so that in the area of the previously existing annular gap a sealing surface at the terminal disk is exposed.

The described manufacture is however complex and therefore cost-intensive. As a result of the hardening time or the time required for cross-linking of the polymer material, it is necessary in mass production of the filter element to provide a large number of casting molds. When on the terminal disk and/or on the sealing member geometric changes are to be realized, all casting molds must be retooled or even new ones manufactured. During the production process also significant expenditure is required in order to prevent a strong adhesion of the hardening polymer material on the casting mold. For this purpose, for each production process a release agent must be applied to the area of the casting mold that comes into contact with the liquid material. This area is also provided additionally with a non-stick coating. Residual adhered material on the casting mold requires always a thorough cleaning after several processing cycle.

On the finished filter element the annular sealing member with its outer surface is exposed so that for avoiding contamination and/or damage it must be covered during transport to the assembly site.

Finally, the end user is faced with the problem that in general he cannot recognize whether he is dealing with a new original part of the manufacturer or with a reprocessed replacement part.

A first object of the invention thus resides in that the manufacture of the filter element of the aforementioned kind should be realized more economically. A further object resides in that a protection of the exposed sealing member is to be effected and a seal function is to be integrated.

### SUMMARY OF THE INVENTION

These objects are solved for an air filter element having the features of the preamble of claim 1 in that the annular seal is covered by a manually removable cover ring and/or in that a central cutout in the terminal disk is covered by a manually removable cover disk.

Preferably, the cover ring is connected directly by two concentric weakened sections to the terminal disk. A rip tab that is integrally formed or connected in other ways makes it possible to partially remove the cover ring and then peel it off along the weakened section so that the sealing member located underneath is exposed and the air filter element can be mounted in the designated housing.

It is also possible to provide a film ring that covers the annular gap in the terminal disk and is glued to the neighboring edge areas of the annular gap. Here, by tearing off the cover ring, the sealing member can be exposed also. The film ring can be comprised of aluminum foil, plastic film or composite materials.

The cover ring can moreover be formed by an auxiliary part pressed into the annular gap of the terminal disk that is in particular formed of synthetic material that has bad adhesion properties, for example, formed of polyethylene, polypropylene, or another polyolefin. Other embodiments may comprise clip-on cover rings.

The annular seal can also be formed on an inner edge of an annular terminal disk. In this case, instead of a cover ring a cover disk is provided that covers the entire central expansion. Otherwise, the same functions and variants are possible as in case of the annular cover.

By means of all embodiments the desired protection for the sealing member is effected and a seal function is provided. At the same time, with the terminal disk configured in accordance with the invention on a filter element, its manufacture is significantly simplified.

A method according to the invention for manufacturing an afore described air filter element provides that casting molds are completely obsolete. Thus, all costs for the manufacture and maintenance of casting molds are eliminated. The elastomer material is filled directly into the covered recesses of the terminal disk wherein the annular gap that is open in operation of the filter element is still closed off by the cover rings provided in accordance with the present invention. The liquid polymer sealing material flows thus only to the cover ring but cannot escape from the casting mold that is formed by the terminal disk itself. The backside of the cover ring effects at the same time a structuring of the sealing member, for example, with additional grooves, and thus functions as a matrix.

An alternative method for producing a filter element provides that instead of a liquid polymer sealing material the terminal disk is to be produced by a two-component injection molding process. In this connection, the sealing member is formed of a thermoplastic elastomer. In this case, there are again tooling costs for the production but the desired protection of the sealing member and the seal function by means of an integrally injection-molded cover ring can also be effected with this manufacturing process.

The weakened sections for later easier removal of the cover ring can also be formed by the injection molding process.

When the seal function provided according to the invention is not required but only the production without casting molds is desired, the cover rings can also be removed automatically during the manufacture of the filter element. The possibility of manual removal facilitates also automated removal: for example, the rip tab can be simply gripped by a stationary gripping device. Subsequently, the filter element is rotated above its center axis so that the cover ring is torn off.

The cover ring can also be expanded by an inwardly positioned circular cover surface so that a completely closed cover disk is provided that at least at its outer edge is connected to the edge area of the sealing ring gap and that upon utilization of the filter element can be completely removed. By covering the central area, the area of the central tube on the filter element is closed off also so that it is additionally protected from dirt penetrating into it. The additional central cover has the additional advantage that with simple measures at the installation site in the air filter housing, for example, by means of a centering projection onto which the filter element is to be pushed, a utilization of the filter element is not possible as long as the cover disk has not yet been removed.

### BRIEF DESCRIPTION OF THE DRAWINGS

The invention will be explained in the following with the aid of the drawings in more detail.

FIG. 1 a filter element in a perspective view;

FIG. 2 a filter element in a perspective longitudinal section view;

FIG. 3 a detail of the head area of the filter element according to FIG. 1;

FIG. 4 a detail of the foot area of the filter element according to FIG. 1;

FIG. 5 a sectioned detail view of the head area; and

FIG. 6 a sectioned detail view of the foot area.

### EMBODIMENT(S) OF THE INVENTION

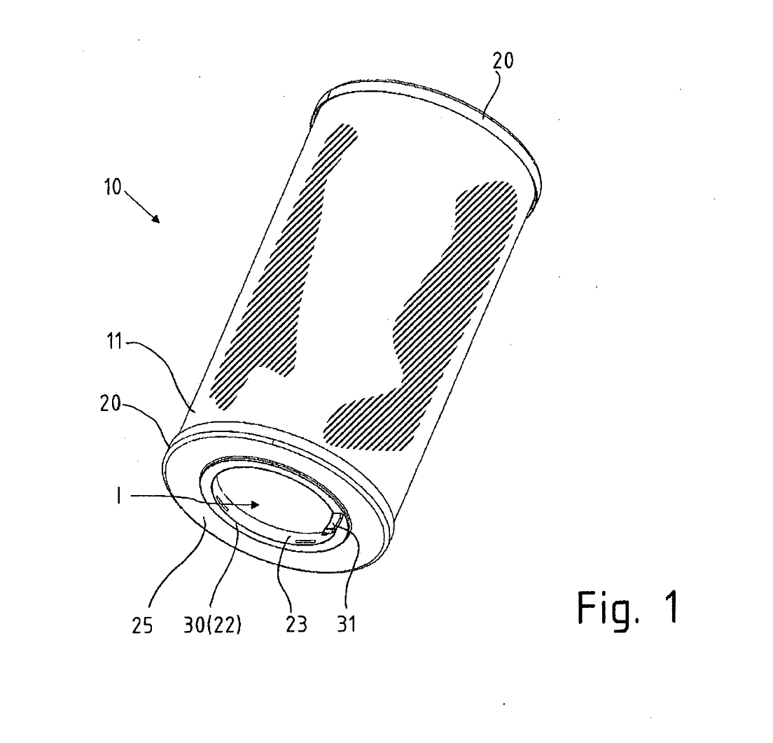

FIG. 1 shows an air filter element 10 with a cylindrical tubular filter bellows 11 of an air-permeable filter medium. At both end faces terminal disks 20 are attached and connected air-tightly to the filter bellows 11. At least one of the terminal disks 20, at least in the state of use of the air filter element 10, is of a ring-shaped configuration so that a central inner flow channel I is formed.

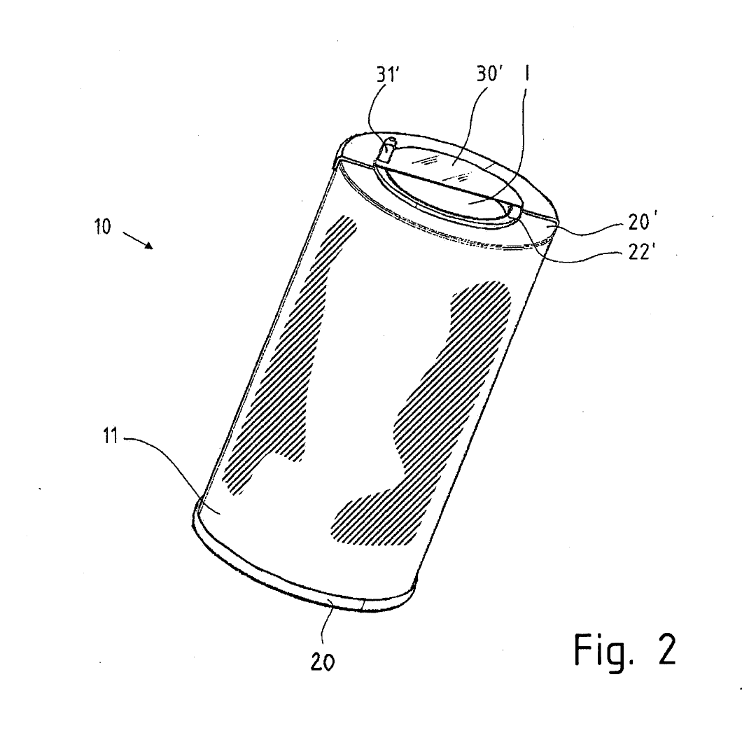

FIG. 2 shows an air filter element 10 in a view from the opposite end. A sealing member 22′ is formed integrally on the terminal disk 20′ and is provided inwardly, in the direction toward a central cutout I, with a sealing lip. With this central opening the filter element 10 is placed or screwed onto a pin in an air filter housing.

The terminal disk 20′ is completely covered by cover disk 30′ wherein FIG. 2 only shows one half of the cover disk 30′ in order to better illustrate the configuration of the filter element 10 located underneath.

In particular, the central inner flow channel I of the filter element 10 is covered so that insertion of the filter element 10 into an air filter housing is not possible until the cover disk 30′ has been removed. For this purpose, the cover disk 30′ is provided with a rip tab 31′ by means of which it can be easily gripped.

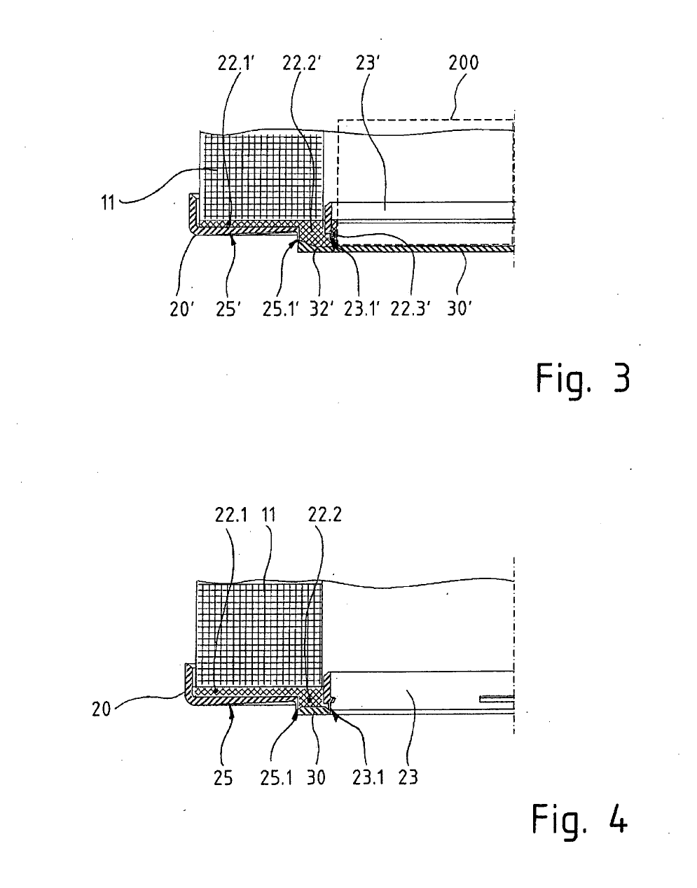

FIG. 3 shows in detail the end of the filter element shown in FIG. 2 with the terminal disk 20′ that is covered by the cover disk 30′ and connected to the filter bellows 11 by the sealing member 22′ that comprises, in addition to the annular sealing sections 22.2′, 22.3′ that provide the actual sealing function, also a connecting area 22.1′. In the area 22.1′ an airtight connection between the filter bellows 11 and an outer annular area 25′ of the terminal disk 20′ is generated.

The outer annular area 25′ ends at a web 25.1. In the direction toward the central inner cutout I the terminal disk 20′ has an additional annular section 23′ that is partially covered on the inner wall surface by the annular sealing section 22.3′ which is part of the sealing member 22′. The cover disk 30′ is connected to the terminal disk 20′ at the tip of the web 25.1′. The wall thickness of this connecting location is very thin in order to facilitate a simple tearing off by hand.

A structured surface area 32′ of the cover disk 30′ serves for forming a structured surface on the annular sealing section 22.2′ of the sealing member.

FIG. 4 shows the other end of the filter element 10 that has been shown before in the perspective illustration of FIG. 1. The sealing member has again a connecting section 22.1 for connecting the terminal disk 22 to the filter bellows 11 and an annular sealing section 22.2. At a spacing from the outer annular area 25 an inner annular area 23 is provided. The annular gap between the two areas 23, 25 is completely filled by the annular sealing section 22.2 of the sealing member. The annular seal 22.2 is covered by a cover ring 30 that is connected with webs 25.1, 23.1 by weakened sections to the terminal disk 20 so that again a simple tearing off by hand is possible. The surface of the cover ring 30 facing the sealing member is structured in order to structure the topside of the annular seal 22.2 that faces outwardly in the position of use.

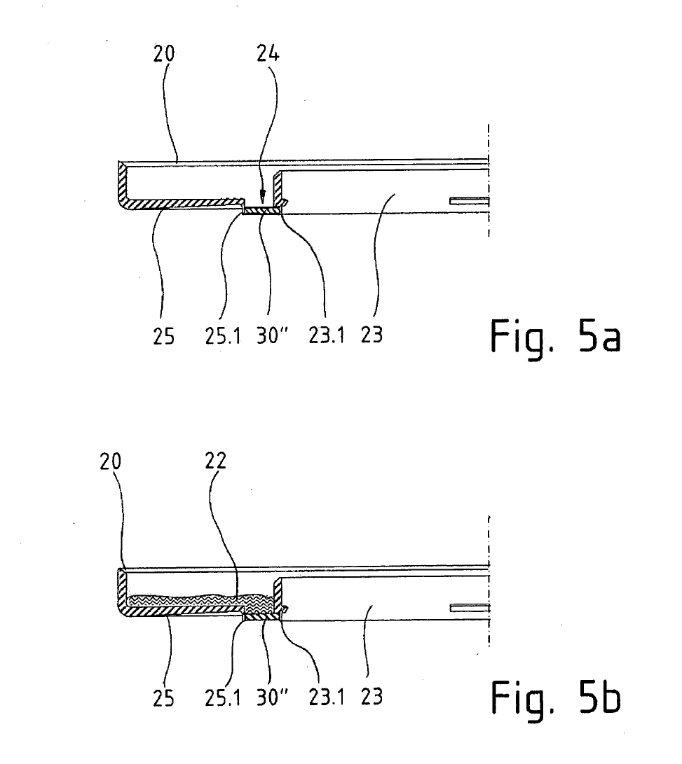

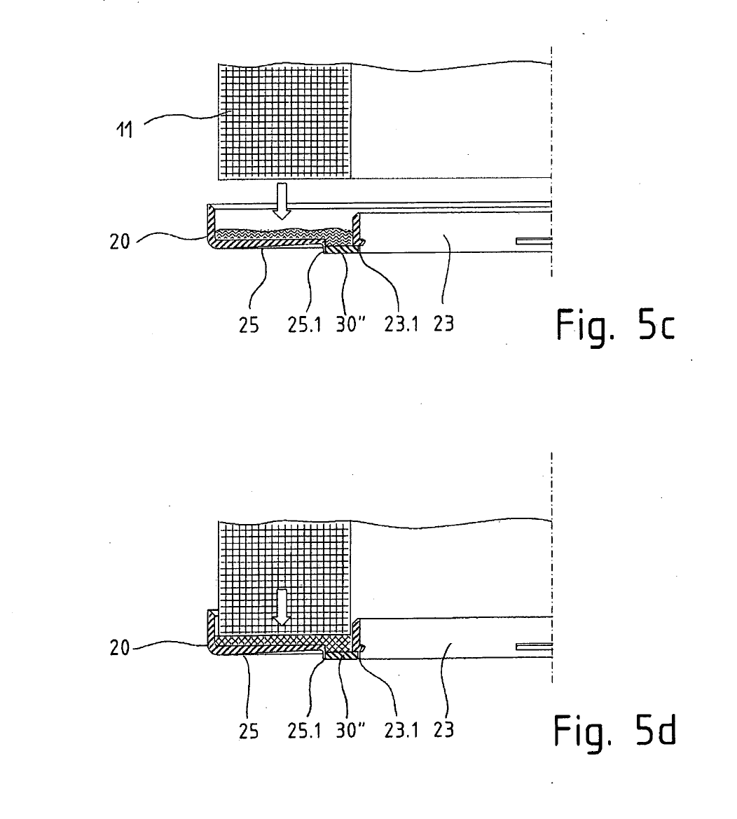

The manufacture of an air filter element 10 according to the invention will be explained in the following with reference to the FIGS. 5a to 5c in more detail.

FIG. 5a shows a terminal disk 20 in accordance with the embodiment illustrated in FIG. 4 which is produced by a synthetic material injection molding process from a thermoplastic synthetic material. A separate cover ring 30″ is pressed into the gap between the outer annular area 25 and the inner annular area 23 and completely closes it off so that a seal-tight casting mold is formed that is comprised of the terminal disk 20 and the cover ring 30, as shown in FIG. 5b.

Subsequently, a suitable material for forming an elastomer sealing member is introduced in liquid or pasty form into the thus formed casting mold wherein the annular gap 24 between the webs 23.1,25.1 is filled and also the outer annular area 25 is covered.

The filter bellows 11 (compare FIG. 5c) is then placed into the not yet hardened or crosslinked material 22 so that the material will adhere to the bottom side of the filter bellows and in this way interstices provided thereat will be sealed tightly. After hardening of the elastomer material according to FIG. 5d one side of the air filter element 10 is completed.

Finally, for the opposite end of the filter bellows 11 a further terminal disk 20′ is oriented such that the surface that faces outwardly again later on during use is facing downwardly and the inner surface is open in the upward direction so that an elastomer material can be filled in and the still free end of the filter bellows 11 can be placed therein. A matrix stamp 200 (compare FIG. 3) may be additionally required in order to be able to produce by means of a casting process a lip section 22.3′ acting centrally as a radial seal. In this connection, a simple cylinder geometry is however sufficient. After hardening or cross-linking the filter element 10 is completely finished.

1. Air filter element (10) comprising a cylindrical tubular filter bellows (11) that is closed off at the end faces by a terminal disk (20, 20′), respectively, which each have at least one annular seal or an annular seal section (22.2, 22.2′) of a sealing member,
characterized in that the annular seal is covered by a removable cover ring (30, 30′) and/or a central cutout in the terminal disk (20, 20′) is covered by a removable cover disk (30′).

2. Air filter element (10) according to claim 1, characterized in that the cover ring (30) is connected by at least two weakened sections (23.1, 25.1) to the terminal disk (20).

3. Air filter element (10) according to claim 1 or 2, characterized in that the cover ring (30) is formed by a film ring.

4. Air filter element according to claim 1 or 2, characterized in that the cover ring is glued to the edge areas of the terminal disk that neighbor the annular gap.

5. Air filter element (10) according to one of the claims 1 to 4, characterized in that the cover ring (30″) can be pressed into or clipped onto the annular gap (24) of the terminal disk (20).

6. Air filter element (10) according to claim 1, characterized in that the cover disk (30′) is connected by at least one weakened section (25.1′) to the terminal disk (20′).

7. Air filter element according to claim 6, characterized in that the cover disk is formed by a film cover.

8. Air filter element according to claim 6 or 7, characterized in that the cover ring is glued to the edge areas of the terminal disk that neighbor the inner cutout.

9. Air filter element (10) according to one of the claims 1 to 8, characterized in that a rip tab (31) is connected to the cover ring (30, 30″) or the cover disk (30′).

10. Air filter element (10) according to claim 3 or 7, characterized in that the film ring or the film cover is formed of aluminum foil, plastic film or composite material.

11. Air filter element (10) according to one of the claims 1 to 8, characterized in that the filter bellows (11) is connected to at least one terminal disk (20, 20′) by a connecting area (22.1′) of the sealing member.

12. Method for producing an air filter element (10) according to at least one of claims 1 to 11, comprising the following method steps:
covering an annular gap (24) and/or an inner central cutout (I) of a body of a terminal disk (20, 20′) with a cover ring (30; 30″) or with a cover disk (30′);
orienting the terminal disk body with the cover ring (30, 30″) and/or the cover disk (30′) facing downwardly;
introducing an elastically hardening and/or cross-linking polymer or polymer mixture into the covered annular gap (24) and/or the covered cutout (I);
repeating the preceding steps for a second terminal disk; and
connecting the filter bellows (11) to the terminal disks (20, 20′).

13. Method according to claim 12, characterized in that a cover ring (30, 30″) and/or a cover disk (30′) is used that is or are at least partially structured at their surface (32) facing upwardly into the annular gap (24) or the cutout.

14. Method according to claim 12 or 13, characterized in that the elastic elastomer is a thermoplastic elastomer that is introduced by a two-component injection molding process into a terminal disk (20, 20′).

15. Method according to one of claims 12 to 14, characterized in that the cover ring (30) and/or the cover disk (30′) is/are integrally formed on the terminal disk (20, 20′).
